(19) United States
(12) Patent Application Publication
(10) Pub. No.: US 2009/0292552 A1
(43) Pub. Date: Nov. 26, 2009

(54) Integrated and interactive health-management system

(76) Inventors: Jiunn-Rong Chen, Taichung City (TW); Song-Yen Tsai, Taichung City (TW)

Correspondence Address: CHARLES E. BAXLEY, ESQUIRE, 90 JOHN STREET, SUITE 309, NEW YORK, NY, 10038, US

(21) Appl. No.: 12/154,259

(22) Filed: May 20, 2008

(51) Int. Cl. G06Q 50/00

(52) U.S. Cl. 705/2

(57) ABSTRACT

An integrated and interactive health-management system allows a medical-care-recipient to transmit both physiological and non-physiological information obtained through his/her self-monitoring to a medical-service platform so that related medical personnel at the platform partaking in the medical treatment can learn the medical-care-recipient's home care status and provide the medical-care-recipient with professional suggestions and assistance accordingly.

### BACKGROUND OF THE INVENTION

1. Technical Field

The present invention relates to a management system basing on mobile and digital technologies. The goal of this invention is to update the health managing services whenever possible. It mainly applies to health managing services. The whole health managing services include a part of various medical treatments provided to a medical-care-recipient in a hospital and another part of the medical-care-recipient's self-care as well as self-monitoring operations conducted at home after discharge from the hospital. The disclosed health management system allows a medical-care-recipient to submit updated self-care and self-monitoring information at his or her convenience to a preset well-organized medical information system.

2. Description of Related Art

When an individual gets sick and seeks for medical assistance from a regular medical system, a medical treatment process is commenced. The term “medical treatment” in a narrow sense may contain outpatient services and resident treatment. The outpatient services generally involve building up medical-care-recipients' personal information, arranging relevant outpatient services for medical-care-recipients, providing diplomates' interrogation enquiries and/or examination arrangement (such as X-ray, blood and urine tests), and giving doctor's advice as well as prescriptions. Hospitalization may take place as needed following the outpatient services and may include admission, collecting and recording medical-care-recipients' vial signs by nurses, collecting medical-care-recipients' medical history by resident doctors, giving advice by doctors in charge, giving prescriptions and medical treatments according to the doctors' advice and continuously monitoring medical-care-recipients' health conditions through the hospitalization.

The aforementioned medical treatment process aimed at curing the medical-care-recipients or controlling the medical-care-recipients' health conditions, is typically commenced after diseases emerge and therefore is considered as a passive solution to remedy diseases. However, for people who have chronic diseases, such as hypertension, hyperlipidemia, diabetes mellitus, etc., after his/her health conditions are stabilized by the aforementioned medical treatment process, competent post-hospitalization self-care, including diet control, taking exercise, monitoring blood pressure and blood glucose conditions as well as taking medicine duly, is even more important. If such self-care is properly conducted, risks of relapse or progression can be significantly reduced. Nevertheless, at present, medical-service-providers and doctors generally have no way to learn about medical-care-recipients' post-hospitalization conditions and medical-care-recipients tend to neglect self-care for lacking professional support. Consequently, controlling and improving health conditions would be a real challenge

Besides, for a medical-care-recipient whose health conditions are not to such an extent where hospitalization is required, such as a person receiving a follow-up treatment for a chronic disease, or a person just having a disease detected in a health examination, if the medical-service-provider has no information about the medical-care-recipient's condition of self-care, it may be difficult for the medical-service-provider to give proper advice in time.

### SUMMARY OF THE INVENTION

The main objective of the present invention is to provided an integrated and interactive health-management system that delivers all related information about a medical-care-recipient's self-care to a medical-service platform at a hospital or a health service center, wherein the information may comprise the medical-care-recipient's diet information, exercise details, blood pressure, values, blood glucose values, body temperature, respiratory frequency, pulse rate, weight, etc, so that medical staff of the medical-service-provider partaking in the relevant medical treatment can be well aware of the medical-care-recipient's health conditions.

For the convenience of illustration, the concept of a “hospital” or a “health service center” is hereinafter represented by the term, “medical-service-provider”.

One objective of the present invention is to provide an integrated and interactive health-management system that implements an integrated-information-display unit to present health conditions of a medical-care-recipient who is to receive a medical treatment for a predetermined duration in a graphical or digital manner. For instance, the medical-care-recipient's blood pressure values at different time points may be expressed by a graph or a histogram so that the medical-care-recipient and a service provider can easily read information in the graph or histogram and identify the medical-care-recipient's health conditions.

Another objective of the present invention is to provide an integrated and interactive health-management system wherein an integrated-information-display unit provided in the system can provide systematically classified health-management information and medical-service records of a medical-care-recipient. For example, if the medical-care-recipient has health concerns about hypertension and liver cirrhosis, the integrated-information-display unit can provide the medical-care-recipient's health-management information and medical-service records relating to hypertension and liver cirrhosis separately.

Another objective of the present invention is to provide an integrated and interactive health-management system that allows an interactive communication between a medical-care-recipient and a medical-service-provider so that the medical-service-provider can be updated with the medical-care-recipient's latest health conditions so that the medical-care-recipient can acquire appropriate professional advice and medical assistance from the medical-service-provider.

Still another objective of the present invention is to provide an integrated and interactive health-management system that serves to realize horizontal linkage among medical-service-providers so as to integrate all anamneses and medical-service records of a medical-care-recipient for allowing the medical-care-recipient or any of the medical-service-providers to have a panoramic view of the medical-care-recipient's medical history.

Yet another objective of the present invention is to provide an integrated and interactive health-management system whereby a medical-care-recipient can be linked with a commercial-transaction unit for purchasing healthy foods or for collecting health information. Also, the medical-care-recipient can communicate with and consult a medical-service-provider through the integrated and interactive health-management system.

The integrated and interactive health-management system of the present invention comprises: a medical-service platform, a medical-care-recipient platform, and a communication platform, wherein the medical-service platform at least includes an electronic-anamnesis unit, a medical-care-recipient's ID unit, and a medical-care-recipient's physiological-information unit. The medical-care-recipient's ID unit stores and processes an ID information of a medical-care-recipient and is in communication with a corresponding medical-care-recipient's anamnesis in the electronic-anamnesis unit. The medical-care-recipient's physiological-information unit is in communication with the medical-care-recipient's ID unit for storing and processing physiological information provided by the medical-care-recipient. The medical-care-recipient platform is built at a residence of the medical-care-recipient and at least comprises an ID-providing unit and a physiological-information-providing unit. The communication platform enables video communication and information transmission between the medical-care-recipient platform and the medical-service-provider.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a diagram showing a hardware configuration of an integrated and interactive health-management system according to the present invention; and

FIG. 2 is a systemic block chart of a medical-service platform according to the present invention.

### DETAILED DESCRIPTION OF THE PREFERRED EMBODIMENT

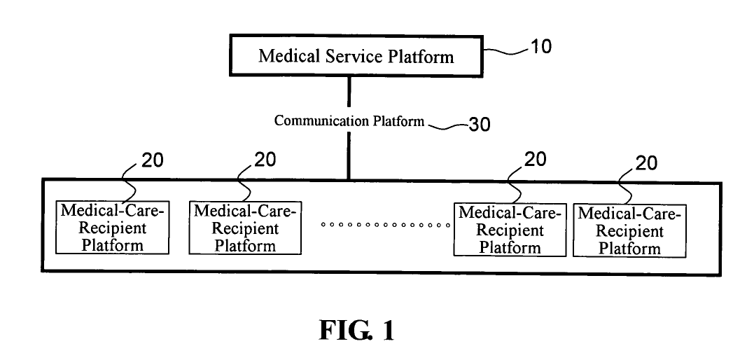

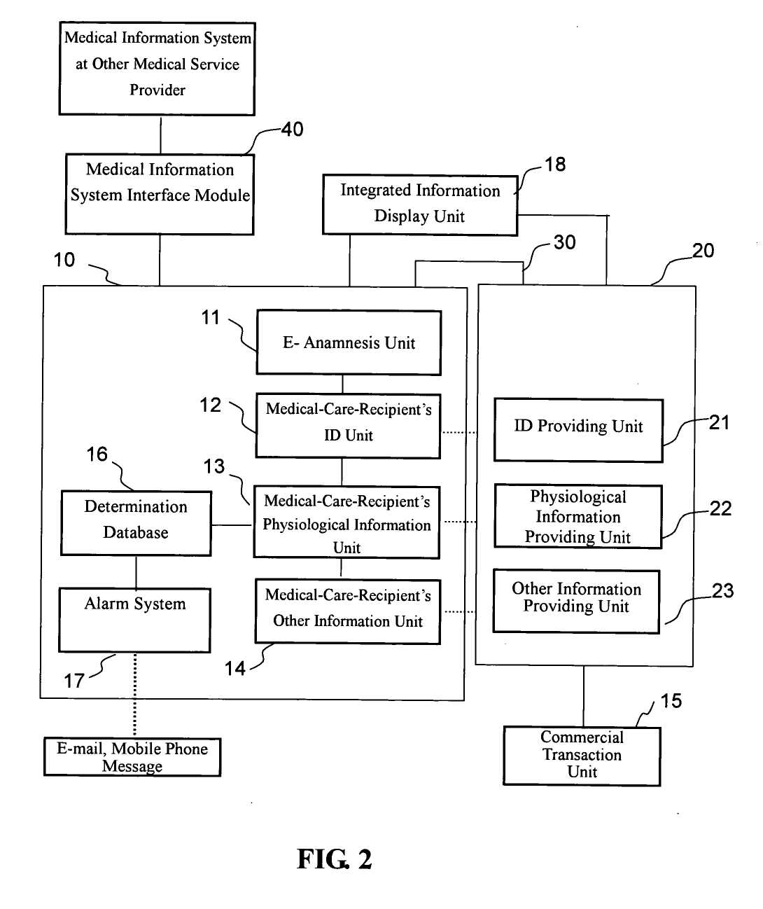

As shown in FIG. 1, an integrated and interactive health-management system comprises a medical-service platform 10, plural medical-care-recipient platforms 20 each built at a medical-care-recipient's residence, a communication platform 30 for connecting each said medical-care-recipient platform 20 with the medical-service platform 10, and a medical-information-system-interface module 40 (shown in FIG. 2) for integrating the medical-service platform 10 with other medical-information systems.

Referring to FIG. 2, the medical-service platform 10 at least comprises an electronic-anamnesis unit 11, a medical-care-recipient's ID unit 12, a medical-care-recipient's physiological-information unit 13, a medical-care-recipient's other-information unit 14 and an integrated-information-display unit 18.

The electronic-anamnesis unit 11 takes each individual medical-care-recipient as a unit for storing and processing the medical-care-recipients' personal anamneses individually. The anamneses may include the medical-care-recipient's personal information, medical-service records and medical history.

The medical-care-recipient's ID unit 12 stores and processes an ID information of the medical-care-recipient and is in communication with a corresponding medical-care-recipient's anamnesis in the electronic-anamnesis unit 11.

The medical-care-recipient's physiological-information unit 13 is in communication with the medical-care-recipient's ID unit 12 for storing and processing a physiological information provided by a medical-care-recipient. The physiological information at least includes blood pressure value, heart rate, respiratory frequency, body temperature, blood glucose value and weight.

The medical-care-recipient's other-information unit 14 is in communication with the medical-care-recipient's ID unit 12 for storing the medical-care-recipient end's non-physiological information, such as time for medicine-taking, exercise items, exercise time, diet details, etc.

The medical-care-recipient may be communicated with a commercial-transaction unit 15 for purchasing healthy foods or for collecting healthy information. Also, the medical-care-recipient can communicate with a medical-service-provider through the medical-service platform 10 for contacting medical-service-providers to get medical advice.

The integrated-information-display unit 18 is in communication with the electronic-anamnesis unit 11, the medical-care-recipient's physiological-information unit 13 and the medical-care-recipient's other-information unit 14 so as to represent the medical-care-recipient's health conditions for a predetermined duration in a graphical or digital means. For instance, the medical-care-recipient's physiological information such as blood pressures, heart rate, respiratory frequency, body temperature and blood glucose or other information such as exercise time and assimilated calories can be expressed by a graph or a histogram. The integrated-information-display unit 18 provides systematically classified health management information and medical-service records according to the medical-care-recipient's diseases. For example, if the medical-care-recipient has health concerns about hypertension and liver cirrhosis, the integrated-information-display unit 18 can provide the medical-care-recipient's health management information and medical services records relating to hypertension and liver cirrhosis separately. The so-called health management information may be any physical and physiological information obtained through the medical-care-recipient's self-examination while the medical services records may comprise all the medical transactions the medical-service-provider has conducted, such as medical history, examination results, prescriptions, etc. Such systematically classified information is a performance of a programmable integration of all materials in the electronic-anamnesis unit 11, so as to allow the medical-care-recipient and the medical-service-provider to fully understand the medical-care-recipient's health conditions and the medical history, examination results, medical-service records as well as the prescriptions with the least time consumption.

Each of the medical-care-recipient platforms 20 is built at a respective medical-care-recipient's residence and at least comprises an ID-providing unit 21, a physiological-information-providing unit 22 and an other-information-providing unit 23. The ID-providing unit 21 transmits the medical-care-recipient's ID information to the medical-care-recipient's ID unit 12. The physiological-information-providing unit 22 transmits the medical-care-recipient's physiological information to the medical-care-recipient's physiological-information unit 13. The other-information-providing unit 23 transmits the medical-care-recipient's non-physiological information to the medical-care-recipient's other-information unit 14. The ID-providing unit 21 and the medical-care-recipient's ID unit 12 may implement the RFID (Radio Frequency Identification) or any other available technology to realize data transmission and verification. The physiological-information-providing unit 22 may be measured and collected by a portable physiological-signal-monitoring device. The portable physiological-signal-monitoring device may be integrated with the ID-providing unit 21, a computer system and a transmission interface into a modulized apparatus. After measuring and collecting the medical-care-recipient's physiological information, the portable physiological-signal-monitoring device can transmit the medical-care-recipient's ID information in company with the physiological information to the medical-care-recipient's ID unit 12 and the medical-care-recipient's physiological-information unit 13.

The communication platform 30 enables video communication and information transmission between the medical-care-recipient platform 20 and the medical-service-provider 10. Thereby, not only the medical-care-recipient platform 20 can submit the medical-care-recipient's physical and physiological information to the medical-service-provider 10, but also the medical-service-provider at the medical-service-provider 10 (such as a doctor in charge) and the medical-care-recipient can have direct video communication so as to provide active, real-time, and professional advice and assistance.

Under the consent of all parties, the medical-information-system-interface module 40 helps to integrate the medical-service platform 10 with other medical information systems of other medical-service-providers so as to achieve horizontal linkage among the medical-service-providers and thereby collect all of the medical-care-recipient's existing information, such as medical history and prescriptions.

The medical-service platform 10 further comprises a determination database 16 and an alarm system 17. The determination database 16 determines the medical-care-recipient's current physiological conditions according to information of the medical-care-recipient's physiological-information unit 13, thereby detecting the medical-care-recipient's potential healthy problems and then setting a physiological information alarming mechanism so that the alarm system 17 can give out an alarm message (in a form of an e-mail or a mobile phone message) to a preset mobile phone number or e-mail address for immediately informing families of the medical-care-recipient or the medical-service-provider.

Now a diabetic is taken as an example for explaining the operation of the health management system of the present invention. First, the diabetic goes to a medical-service-provider, namely a hospital, and the diabetic's personal information, medical history, SOAP (Subjective, Objective, Assessment, Plan) notes, prescriptions, vital signs, related medical examination results, medical imaging diagnostic reports and so on are particularly recorded in the electronic-anamnesis unit 11 of the hospital. A doctor in charge of taking care the diabetic can easily read all the recorded information relating to the diabetic through a computer in the hospital. The diabetic then convalesces and joins an interactive health management project supported by the hospital by building the medical-care-recipient platform 20 at his residence after leaving the hospital. The diabetic enters his medical-care-recipient's ID information in the medical-care-recipient's ID unit 12 so that the medical-care-recipient's ID information is linked with a corresponding medical-care-recipient's anamnesis in the electronic-anamnesis unit 11. The diabetic is allocated with a modulized blood glucose meter that integrates a portable physiological-signal-monitoring device, the ID-providing unit 21, a computer system and a transmission interface. Each measured blood glucose value can be directly submitted to the medical-care-recipient's physiological-information unit 13 and the medical-care-recipient's ID unit 12 for the medical-care-recipient's physiological-information unit 13 to then process and store the blood glucose value so that the doctor in charge can learn about the diabetic's blood glucose control by reading the information returned from the medical-care-recipient platform 20 in front of the computer in the hospital anytime to and well know the diabetic's health conditions through the medical history and medical-service records in the electronic-anamnesis unit 11. On the other hand, the diabetic's diet, exercise items, exercise time, time for medicine-taking can be transmitted to the medical-care-recipient's other-information unit 14 through the other-information-providing unit 23 (such as a computer or a mobile communication device and an exclusive software) so as to allow the doctor to know the diabetic's daily life status. When one of the doctor and the diabetic requires direct communication with the other, the both can use the communication platform 30 to have a video communication therebetween.

The determination database 16 and an alarm system 17 can serve in an emergency. For example, when any of the diabetic's vital signs, such as hear rate, blood pressure and breath) becomes instable, the determination database 16 of the medical-service platform 10 can actively detect the instable situation and drives the alarm system 17 to give out an e-mail or a mobile phone message so as to immediately inform the diabetic's families or doctor to provide medical aid.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. An integrated and interactive health-management system, comprising:
a medical-service platform, including an electronic-anamnesis unit, a medical-care-recipient's ID unit, and a medical-care-recipient's physiological-information unit, wherein the medical-care-recipient's ID unit stores and processes an ID information of each medical-care-recipient and is in communication with a corresponding medical-care-recipient's anamnesis in the electronic-anamnesis unit and the medical-care-recipient's physiological-information unit is in communication with the medical-care-recipient's ID unit for storing and processing each physiological information provided by each said medical-care-recipient;
at least one medical-care-recipient platform, each built in a residence of a medical-care-recipient and at least comprising an ID-providing unit and a physiological-information-providing unit, wherein the ID-providing unit, wherein the ID-providing unit transmits the ID information of each said medical-care-recipient to the medical-care-recipient's ID unit and the physiological-information unit transmits a physiological information to the medical-care-recipient's physiological-information unit; and
a communication platform, enabling a video communication and an information transmission between the medical-care-recipient platform and the medical-service platform.

2. The integrated and interactive health-management system of claim 1, wherein the physiological information is derived by a self-examination of the medical-care-recipient.

3. The integrated and interactive health-management system of claim 2, wherein the physical information at least comprises a blood pressure value, a heartbeat frequency, a respiratory frequency, a body temperature value, or a blood glucose value.

4. The integrated and interactive health-management system of claim 2, wherein the physiological-information-providing unit is a portable physiological-signal-monitoring device.

5. The integrated and interactive health-management system of claim 1, wherein the medical-service platform further comprises a medical-care-recipient's other-information unit and the medical-care-recipient platform further comprises other-information-providing unit, in which the medical-care-recipient's other-information unit is in communication with the medical-care-recipient's ID unit for storing a non-physiological information provided by the medical-care-recipient and the other-information-providing unit transmits a non-physiological information of the medical-care-recipient to the medical-care-recipient's other-information unit.

6. The integrated and interactive health-management system of claim 5, wherein the non-physiological information at least comprises a time for taking medicine, an exercise item, an exercise time, or a diet detail.

7. The integrated and interactive health-management system of claim 1, wherein the medical-service platform further comprises a determination database and an alarm system, in which the determination database determines current physiological conditions of the medical-care-recipient according to information of the medical-care-recipient's physiological-information unit and drive the alarm system to give out an alarm message to a specific object.

8. The integrated and interactive health-management system of claim 7, wherein the specific object is a preset e-mail address or a mobile communication device.

9. The integrated and interactive health-management system of claim 7, wherein the alarming message is an e-mail or a mobile phone message.

10. The integrated and interactive health-management system of claim 1, wherein the medical-service platform further comprises an integrated-information-display unit, which is in communication with the electronic-anamnesis unit, the medical-care-recipient's physiological-information unit and the medical-care-recipient's other-information unit and presents the information in the units in a graph or a histogram.

11. The integrated and interactive health-management system of claim 10, wherein the integrated-information-display unit provides the information in the units in such a manner that the information is systematically classified according to diseases of the medical-care-recipient.

12. The integrated and interactive health-management system of claim 1, further comprising a medical-information-system-interface module for integrating the medical-service platform with other medical information systems.
